(19) United States
(12) Patent Application Publication
(10) Pub. No.: US 2015/0062899 A1
(43) Pub. Date: Mar. 5, 2015

(54) Power Cord

(71) Applicant: PEI-JUNG YANG, New Taipei City (TW)

(72) Inventor: PEI-JUNG YANG, New Taipei City (TW)

(21) Appl. No.: 14/014,376

(22) Filed: Aug. 30, 2013

(51) Int. Cl. F21K 99/00; F21V 23/00

(52) U.S. Cl. CPC F21K 9/30; F21V 23/001
USPC 362/249.02; 362/249.01

(57) ABSTRACT

A power cord is provided, including at least one light-emitting device provided with two first terminals and two second terminals; at least two first lead wires, in which one end of each of the two first lead wires is connected to each of the two first terminals and the other end of each of the two first lead wires is electrically connected to an external power source; and at least two second lead wires, in which one end of each of the two second lead wires is connected to each of the second terminals and the other ends of each of the two second lead wires are connected to each other, thereby the first lead wires, the second lead wires, and the light-emitting device being connected to form a loop.

### (a) TECHNICAL FIELD OF THE INVENTION

This invention relates to a power cord and particularly to a power cord connecting and working with a SMD LED device with illumination functions.

### (b) DESCRIPTION OF THE PRIOR ART

Nowadays, power cords commercially available function to only provide electrical connection. By means of connecting to a power source and load that completes an electric loop, electricity is provided to power-up various electronic and mechanical devices.

Conventional power cords are a must when working with various electronic products, such as mobile phone chargers, hair-dryers, electric fans or other large appliances; when not being used, the power cords are generally stowed aside for fear of disorder. To users, power cords for appliances are a must. However, once plugging the power cord into a wall outlet, the user will be trying to arrange the power cord and even have to use other tools to arrange it, which is obviously inconvenient and imperfect in practical use. It goes without saying that the power cord is part of the appliance, but, in the industry, the power cord is seldom properly designed for an extra function other than that of electrical power transmission.

Further, no matter in a house or an office, there are many computers and appliances. When the number of power cords increases, it is difficult to identify the corresponding relationship between a power cord and its connected appliance; thus, it is often necessary to lift up the power cord in order to find the wanted or corresponding power cord among the numerous power cords, or even move the appliances away from the wall for ease of search and sorting out each power cord. The numerous defects mentioned above have not been improved over the years.

Consequently, because of the technical defects described above, the applicant, based on many years of research and experience in the relevant industry has developed the present invention, which may effectively improve the defects described above.

### SUMMARY OF THE INVENTION

In view of the above-mentioned defects, the power cord according to this invention comprises at least one light-emitting device provided with two first terminals and two second terminals; at least two first lead wires, in which one end of each of the two first lead wires is connected to each of the two first terminals and the other end of each of the two first lead wires is electrically connected to an external power source; and at least two second lead wires, in which one end of each of the two second lead wires is connected to each of the second terminals and the other ends of each of the two second lead wires are connected to each other, thereby the first lead wires, the second lead wires, and the light-emitting device being connected to form a loop.

This invention is mainly to provide an improved power cord that may independently work as lighting and may also work with various electronic devices or articles for increasing its added value so that the user does not have to deliberately conceal the power cord and can make the power cord serve as a natural ornament in a home or an office.

This invention is further to provide an improved power cord that may be applied by the user optionally to a required electronic device or another article without the need of purchasing extra lamp bulbs and wires.

### BRIEF DESCRIPTION OF THE DRAWINGS

FIG. 1 is a 3D view of a power cord according to this invention;

FIG. 2 is a 3D exploded view of the power cord according to this invention;

FIG. 3 is a schematic view illustrating the power cord in a first embodiment of this invention; and

FIG. 4 is a schematic view illustrating the power cord in a second embodiment of this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

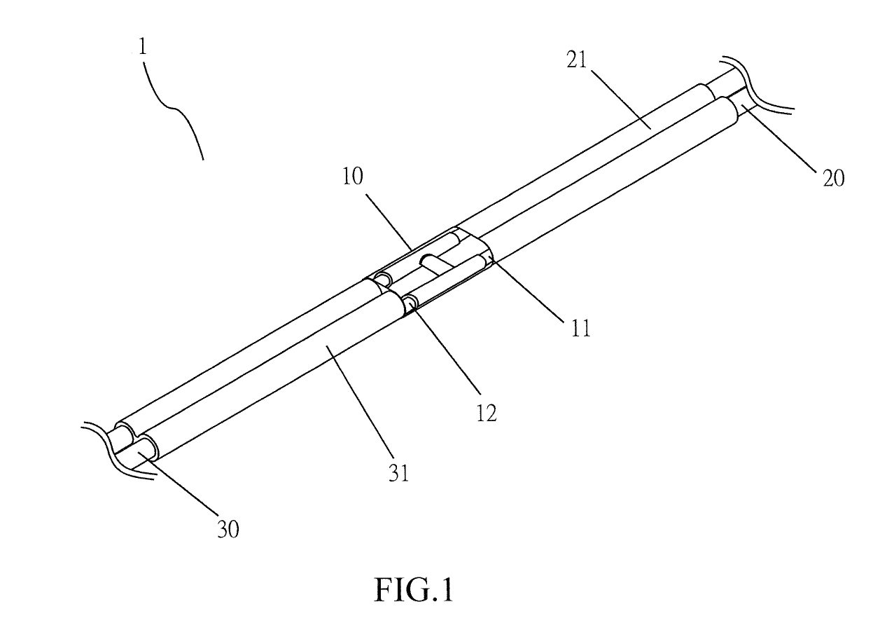

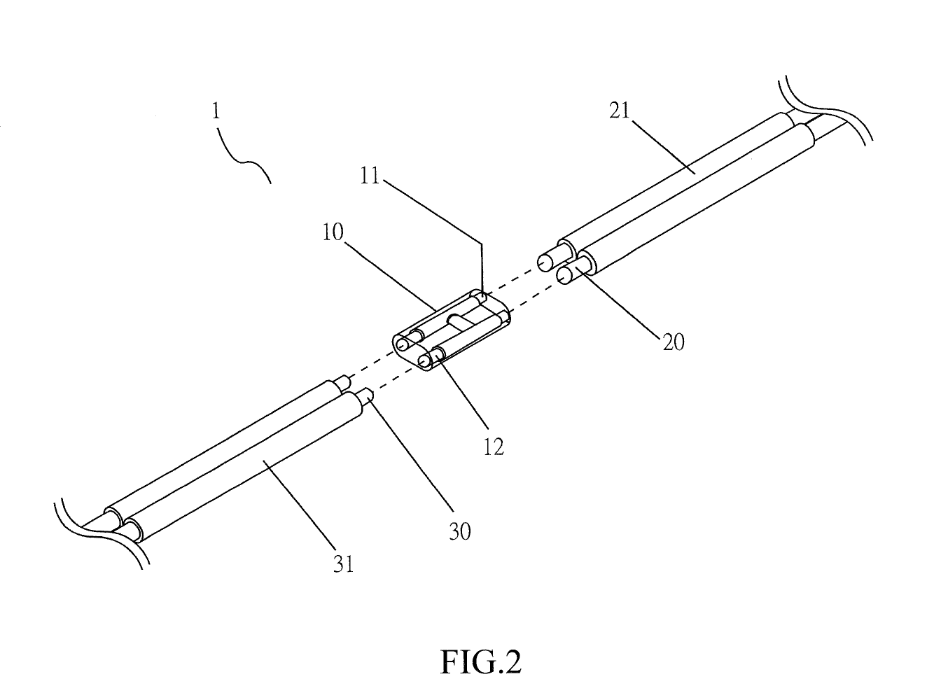

Firstly, referring to FIGS. 1 and 2, a power cord 1 according to this invention comprises a light-emitting device 10, at least two first lead wires 20, and at least two second lead wires 30.

The light-emitting device 10 is provided with two first terminals 11 and two second terminals 12. The light-emitting device 10 is a surface mount device LED (SMD LED).

One end of each of the two first lead wires 20 is connected to each of the two first terminals 11 and the other end of each of the two first lead wires 20 is electrically connected to an external power source. The power cord 1 according to this invention may work with a power source of DC 12V, DC 9V, or AC 110˜220V

One end of each of the two second lead wires 30 is connected to each of the second terminals 12.

Each of the two first lead wires 20 is wrapped with an insulated first sleeve 21, while each of the two second lead wires is wrapped with an insulated second sleeve 31.

The first sleeves 21 are connected to each other and the second sleeves 31 are also connected to each other; thus, the first sleeves 21 and the second sleeves 31 are all formed in one, respectively.

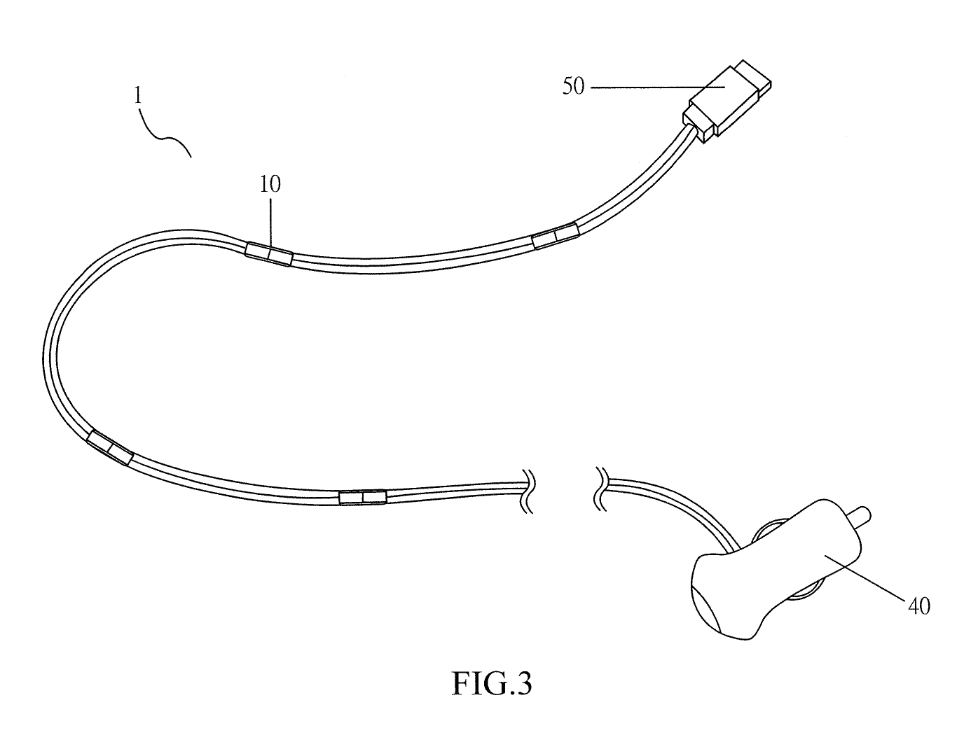

Referring to FIG. 3 as a schematic view illustrating the power cord in a first embodiment of this invention. One end of each of the first lead wires 20 (as shown in FIG. 2), opposite to the other end connected to each of the first terminals 11, as shown in FIG. 2, is electrically connected to a power plug 40 that is thereby plugged into a power socket 40 (not shown) for making each light-emitting device 10 illuminate; the other end of each of the second lead wires 30, as shown in FIG. 2, may also be connected to an electronic device 50, such as a charger connector or an appliance, allowing the user to simultaneously experience the sensation of visual variation and its entertainment effect while using electronic device 50.

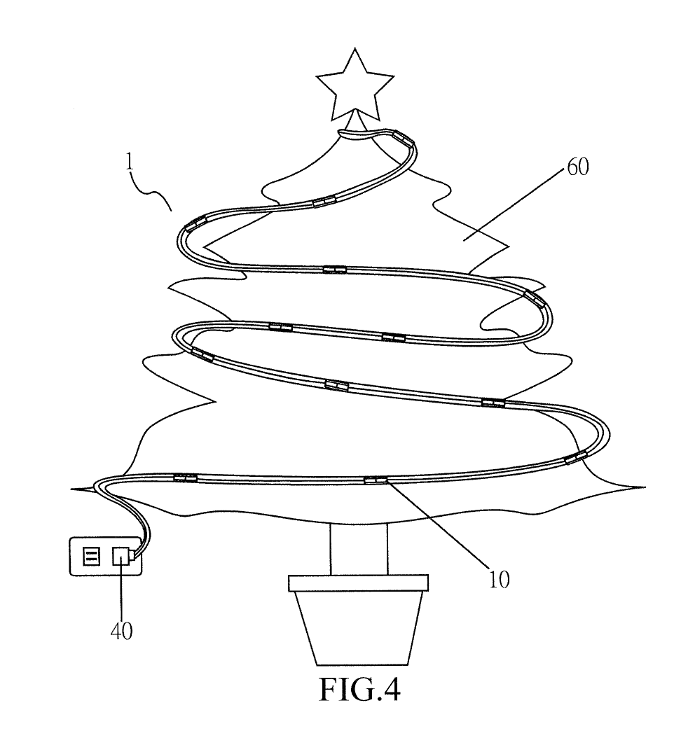

Referring to FIG. 4 as a schematic view illustrating the power cord in a second embodiment of this invention. In this embodiment, one end of each of the first lead wires 20 (as shown in FIG. 2), opposite to the other end connected to each of the first terminals 11, as shown in FIG. 2, is electrically connected to an external power source (not shown); the other ends of each of the two second lead wires 30, as shown in FIG. 2, are connected to each other, thereby the first lead wires 20, the second lead wires 30, and the light-emitting device 10 being connected to form a loop. The power cord 1 may be used in a variety of products and thus may be used as decoration lighting, and may be even made to entwine around a Christmas tree 60 depending on user demand.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

I claim:

1. A power cord, comprising:
at least one light-emitting device, being provided with two first terminals and two second terminals;
at least two first lead wires, one end of each of the two first lead wires being connected to each of the two first terminals and the other end of each of the two first lead wires being electrically connected to an external power source;
at least two second lead wires, one end of each of the two second lead wires being connected to each of the second terminals

2. The power cord of claim 1, wherein the other ends of each of the two second lead wires are connected to each other, thereby the first lead wires, the second lead wires, and the light-emitting device being connected to form a loop.

3. The power cord of claim 1, wherein the other end of each of the second lead wires is connected to an electronic device.

4. The power cord of claim 1, wherein each of the two first lead wires is wrapped with an insulated first sleeve and each of the two second lead wires is wrapped with an insulated second sleeve.

5. The power cord of claim 4, wherein the first sleeves are connected to each other and the second sleeves are connected to each other.

6. The power cord of claim 1, wherein the light-emitting device is a SMD LED.
